(19) United States
(12) Patent Application Publication
(10) Pub. No.: US 2020/0218712 A1
(43) Pub. Date: Jul. 9, 2020

(54) Method for creating a Database Management System

(71) Applicant: David W. Urry, San Rafael, CA (US)

(72) Inventor: David W. Urry, San Rafael, CA (US)

(21) Appl. No.: 16/734,404

(22) Filed: Jan. 5, 2020

Related U.S. Application Data
(60) Provisional application No. 62/788,817, filed on Jan. 5, 2019.

(51) Int. Cl. G06F 16/23; G06F 16/2455; G06F 16/27

(52) U.S. Cl. CPC G06F 16/2379; G06F 16/27; G06F 16/2365; G06F 16/24568

(57) ABSTRACT

This patent amends Application 62/788,817. A method and system are disclosed or creating, reading, updating and deleting data in a datastore. The datastore uses ordered records called datastreams for propagating data records from multiple sources to multiple destinations with multiple formats. Datastores are also addressed and maintain ACID properties consisting of atomicity, consistency, isolation, durability, temporality and accumulation of data. A datastream consists of a series of complex records. Records may or may not contain multiple, overlapping subsets of records, called tuples, which are relevant to data domains, each tuple requiring a separate storage action.

### REFERENCE

This patent amends Application 62/788,817

### FIELD OF INVENTION

The present invention relates to: (1) methods for creating, reading, updating and deleting data in a datastore, (2) methods for transferring and replicating data via streams, (3) providing concurrent access to data by multiple request types (creating, reading, updating and deleting) concurrently.

### BACKGROUND OF INVENTION

### Prior Art

Computer Science can be divided into three main fields. Applications, Programming Languages, Data Storage. Applications (for example a phone application) interact with the outside world and generally gather information and/or report information. Applications are written in Programming Languages but languages like Java, C, C++, Assembly Language or JavaScript are distinctly different from applications and provide a way for an application to run sets of instructions. Data Storage is a third field of Computer Science where information gathered from Applications is organized and stored for later retrieval. While a DBMS is an application written in a computer language, it is distinctly different as noted by IBM, Oracle, Informix, Sybase and others specifically defining DBMS systems.

DBMS

Database Management Systems as a concept began in 1960 when Charles Bachman designed the first DBMS. Charles Bachman's Navigational Database defined keys, foreign and primary (https://en.wikipedia.org/wiki/Navigational_database). In 1960, Charles W Bachman designed the Integrated Database System designed to allow an individual to navigate a collection of data independent from an application. In 1970 Edgar F. Codd developed the relational database model with a sub-language known as SQL. Codd laid down a series of rules for data storage. The storage method is described as transactions which insure the accuracy of the data recorded. In 1978, C. J. Date published detailed models of how to relate complex records to simpler records in a database. Date's concept was called normalization such that all data of a specific domain was named once and only once. parts of complex records are broken down according tothe rules of second-order logic (https://en.wikipedia.org/wiki/First-order_logic) as expressed in Codd's definition first normal form (https://en.wikipedia.org/wiki/First_normal_form). However, database designs may not accomplish first normal form so the breakdown of the complex record into its domain components is customized to each data store.

Together Cobb, Bachman, Date and others came up with a second order logic of unique sets defined by keys and domains. This group and those following them concluded that a record contained sets, each set fitting into a domain and that a record to maintain its integrity must be managed in isolation of other records to store it and maintain a consistent representation of a database comprising sets and domains.

This application diverges from database theory at this early point to say that sets can be handled in domains across records (rather than within records) and it is the domains and optionally set order that must be maintained in order to maintain a consistent representation of a database comprising domains of sets. The application states that set order is optional in some cases For example, if the set is a customer address the order that it is stored in the database is not important; whereas, if the set is a sales order line item for a limited quantity of inventory it's order is important relative to other line items for the same limited quantity of inventory. Throughout the subsequent 50 years many contributors have done extensive work to optimize these theories both in terms of better ways to do transactions, how to handle multiple, overlapping transactions, how to handle server clusters, sharding disks and servers, how to improve performance and insure recoverability in all situations.

DBMS typically deal with taking complex records and storing them for later access. DBMS store records in a granular form with a long-term storage device like a disk, static memory or other permanent storage devices using the methods described by Codd. Date and others.

Over time, there are certain theorems that are assumed like the CAP theorem which puts limits on the performance and expansion of systems; https.//en.wikipedia.orag/wiki/CAP_theorem. The CAP theorem also demonstrates the limits of the existing data theory.

All database management systems use a “transaction protocol” that involves separate actions for reading, calculating and writing data. These actions are separated logically and temporally creating needs for read locks, write locks, transaction boundaries, isolation levels and other work. Many systems have used in memory data systems like U.S. Pat. Nos. 6,457,021B1, 9,009,116B2 (https://patents.google.com/patent/US6457021B1/en?q=In&q=Memory&q=DataBase&q=transactions&oq=In+Memory+DataBAse+transactions, https://patents.google.com/patent/US9009116B2/en?q=In&q=Memory&q=DataBase&q=transactions&oq=In+Memory+DataBase+transactions) to execute transactions based on data locking, transaction boundary conditions, isolation levels, snapshots, data copies, journalling and the like. All these methods are based on transactional boundaries with each transaction getting an isolated unchanging view of a database as originally described by Codd (1970), SQL'92 (1992), and others.

Database management systems must be recoverable. As such, may systems have been developed to record incoming records, journal them and keep the reported state of the system in sync with the data store. A Journal, separately from a log, keeps track of changes within a datastore so that the datastore requires less modification per write at the cost of more time/and cpu usage per read.

A datastream is information in a flow. Datastreams may be broken down into records by time, information sets or other, multiple arbitrary formats. Datastream records can be replicated to other streams to store each stream in a data store or each stream record can be divided into tuples.

A Database Management System, whether it be a document database, object database, a relational database, some other form of database, divides data into domains. Domains are generally sets of related data. For example a company's customer list would go in the “Customer” domain. Where as a company's orders would go in the “Order” domain, In document databases, this would generally be represented by Customer and Order records respectively. In an Object database this would result in a Customer class and an Order class. In a relational database, an Object table and a Customer table. In this example, Customer and Order may or may not be stored in multiple domains.

A record, in the parlance of this document, is a series of topic/value pairs describing something of interest. The pairs are represented in some computer code for representing characters, for example ASCII. The record, and thus the representation may or may not be encrypted, in machine language or otherwise non-human readable. The topic may be part of the record or it may be implied by the record structure. The result is a series of values. These values can be sorted into overlapping sets that constitute domains. A value domain, which is generally determined by the database implementation through a process called normalization.

In order to maintain atomicity, consistency, isolation, and durability (ACID) properties, a data store must store a record and all its parts consistently. These transactional boundaries define APIs where there is a “BEGIN”, “read”, calculation, “write”, and COMMIT cycle where the “read”, calculate, “write” cycle can be done many different ways but the basic transactional methodology is almost universal. SQL92 defines this and includes a complex series of isolation levels and “dirty”, “fuzzy” and “phantom” read issues that can occur (U.S. Pat. No. 5,870,758A https://patents.google.com/paten/US58700758A/en).

IBM defines an equally complex set of controls for each data element: connect, disconnect, store, restore, delete, init, unlnit and data elements are stored in a larger transactional element. It is the application programmer's responsibility to deal with these boundaries and execute code that both deals with these boundaries and resolves the resulting read lock, write lock, and deadlock issues as well as the performant issues that arrive (U.S. Pat. No. 6,018,743 https://patents.google.com/patent/US6018743/en).

Complex records sometimes described as business records would typically contain single records that cross multiple domains. For example a Customer Order record would typically have Customer, Order, Inventory, Payment, Tax and other domains within the Customer Order record. A record may or may not be divided into its respective domains to store it in a data store. Whether done serially or in parallel, the ‘transaction’ concept requires that each transaction has its own consistent view of the data from the time the transaction is started till the time it is completed.

Deadlock is one of many common problems when processing multiple transactions simultaneously. deadlock occurs when two transaction locks information in different domains and then require information locked by the other transaction in the other domain.

Client Server Architecture

A typical DBMS separates data operations from “application operations”. In 1996 Martin Fowler published Analysis Patterns, in 1997 he published UML Distilled, in 1999 he published Refactoring, in 2002 he published Patterns of Enterprise Architecture, The books together were the basis for separation of logical layers in software development. They reinforced the work already done by Cobb and Date that emphasized that data was stored in the DBMS and calculations were done in application logic. As such, the industry as a whole has adopted the database lock, application read, application calculate, application write and database unlock methodology. This methodology creates “liveliness” issues within a DBMS and is a large contributor to deadlock.

Object Oriented Programming

Many application programs and APIs use an object-oriented programming (OOP) data model. The Object in OOP refers to a single set of instructions that defines in memory data and the operations that operate on them. Objects of the same type are called classes. Thus, an object is said to encapsulate class attributes (or data structures) and methods. The number of objects that might exist in a given OOP model is limited only by the size of computer memory. (from (U.S. Pat. No. 6,018,743A https://patents.google.com/patent/US6018743A/en).

The Thread

A “thread, also referred to as a “lightweight process is an entity of an operating system (Unix, Linx, MacOS, Windows or others) scheduled for execution on a CPU. A thread invokes executable code, such as various application-specific handlers, and may include, among other things, the contents of a set of registers representing the state of the CPU, one or more stacks, and a private storage area. The application-specific handlers include and/or invoke data and business service procedures that have been written by a developer for a particular application. A server that runs in Such an environment can take advantage of the operating systems threaded nature to reduce the complexity of the server and to perform dynamic load balancing (from U.S. Pat. No. 835,958B2 https://patents.google.com/patent/US8389595B2/en). A thread or the code a thread operates on, may or may not have control points to prevent other threads from accessing the same programing instructions at the same time.

References, Pointers and IDs

Program languages generally consist of instructions and data. These segments of instructions and individual data elements can generally be referenced in several different ways. Furthermore, there are techniques for referencing remote segments of code with a pointer to that code, often called a ‘handle’. As such references, pointers and ids all represent different ways of accessing resources that may or may not be remote. Where one term is used, the others can apply, the difference is the method use to access the resource and thus, anywhere the term ‘id’, ‘pointer’ or ‘reference’ is used in this text the other two access methods will apply. None of the terms in this document used this way refer to only one technique for accessing resources and when one is used, any of the techniques may apply.

### SUMMARY OF INVENTION

This application specifically seeks to patent a fundamental different type of DBMS systems by changing the fundamental rules behind DBMS, and is the patenting of a technique for manufacturing (or operating) a data store. The technique is independent of specific programing languages, data structures or data stores described in the embodiment.

This invention comprises major and minor parts that are all independent but comprise a method and apparatus for creating a database management system (DBMS) that follows nontraditional ACID management. The highest level components are datastreams as input system, a record processing system and a data storage system.

A datastream contains complex records, that become one or more information management requests (IMR). An IMRs are fulfilled in such a way as to maintain ACID without using traditional transaction boundaries. The data store, which can be a proprietary DBMS or any currently marketable DBMS, then stores the data to permanent storage.

Datastream: An ordered sequence of complex records and associated tracking data capable of making requests of a data store. In addition to the data in the complex record, the datastream tracks to origin of the complex record, maintains a set of complex records, and keeps track of the graph of datastreams as a datastream may spawn other datastreams. Datastreams may be transmitted to the computer from other sources, be built in the application, or both.

Complex Record: Is a record that covers a topic rather than a single domain consisting of data from one or more database domains. A complex record may be a purchase order with line Items each line item having an inventory number, description and an amount. The inventory number, description and amount would be in the inventory domain. The same dataset may be in the line item domain. In addition the data in a complex record, the record may contain a unique identity to clearly differentiate it from other complex records, and a reference to its origin so that information can be sent back to that origin about the storage of the complex record.

Each complex record has domains and each domain has a set of elements that defines a unique set within the data store domain of sets. For example: In an RDBMS domains are described as tables and sets are described as rows. An object DBMS (ODBMS) describes a domain as a class of objects and a set as the objects state. In Document DBMS (DDBMS) domains are described as documents and sets are name/value pairs (generally).

Information Management Request (IMR): A domain dataset from a complex record corresponding to a specific to a database domain. The IMRs contains a domain dataset from a complex record, the instructions on how to modify the datathread to incorporate the IMRs domain dataset into a specific data store domain, and a reference to the complex record that recorded it. The purpose of an IMR is to hold the data and instructions for storage of a domain dataset.

Datathread: Defined in this document as an in memory (resident) domain dataset with the value of the dataset in the data store that it originated from, the current value of the dataset based on all the IMRs that have been added to it, and a set of the added IMRs. Datathreads are kept in a Datathread pool: An in memory (resident) set of all datathreads. Datathread pools are useful for looking up datathreads that have already been instantiated and allow for a singleton design pattern where by there is only one datathread for each domain dataset.

In memory (resident): This is a state where an item might appear to be in memory but may actually stored to a longer term storage system. Essentially a page swapping system for data that appears to be in memory but, in order to expand a systems memory, is actually on a longer term storage system. Such a paradigm may be necessary for very large domain sets. The management of the in memory (resident) data may be done by the application or by the operating system.

Data Store: A DBMS where data is stored. Examples of datastores are RDBMS, OODB, Document DB, and multi-dimensional data store.

Database Domain: An organizational boundary in a database. Each database domain has a topic and a set of data elements. Each data element contains a key which uniquely identifies that set of elements in that domain. For example a purchase order database may be organized around customer, inventory, payment, order, lineitem and other domains. Since databases are designed by individuals and very a domain is determined by the database design and two databases organized around purchase orders may have different domains—a purchase order for services may have no inventory domain at all—for example.

Domain Dataset: A subset of the data of a complex record that specifically matches a unique set of data in the database domain. An example of a database domain is inventory and may be represented as a structure of the same name in the database. In this example inventory item number “1” would map to a single type of item for which there may be several (say 10) in stock. The database domain dataset may be the inventory item number, a description and an amount. Together the inventory item number, description and amount constitute a domain dataset—both (separately) in the complex record and in the database. Domain datasets may overlap as described in the purchase order example above. These sets are dependent on how the particular database was designed and the domain manager keeps track of what data elements are in which domain datasets.

Domain Manager: A set of code that manages all the IMRs and datathreads in a given domain. It identifies the domains and keys in the complex record, creates a IMR structures from them and identifies the same domains in the data store to setup the datathreads. Then it matches the domain dataset in the IMR to the domain dataset in the datathread. The current invention uses the term Domain Manager but in the provisional patent it was called the Key Processor.

Error Message: A message sent from an IMR to a complex record instructing the complex record that it was not able to process one of the IMRs associated with it.

Result: A message sent from an IMR to a Record instructing the record that the IMR was processed successfully and containing a domain dataset that represents new values or requested values that resulted from the IMR.

### BRIEF DESCRIPTIONS OF THE DRAWINGS

FIG. 1 depicts a computer system 200 with a data stream 207. Computer system may compile information into a stream from multiple sources including but not limited to human input, analog to digital conversions as occurs with passive environmental systems or an application creating data from artificial or actual sources.

FIG. 2 depicts the replication of datastreams. A datastream can send data to multiple other streams and data stores. For example, one copy of the datastream may be written to disk to insure an accurate, recoverable depiction of the datastream exists 110. A second stream may be written to a relational database that tracks financial records 109a. A third stream may be written to a replicated relational database that tracks the same financial records 109b. A fourth stream may be written to a shard of a database that tracks inventory records 109c. A fifth stream may be written to a separate shard of the same database that tracks inventory records 109d. A sixth stream may be used to write to a document database and on ad infinitum. The only modification to the streams (109 110 109a-d) is the “origin id” 107 which for the original datastream 109 is null and for the replicated streams (110 109a-d) is the originating stream 109.

The origin id 107 is used to propagate error messages (FIG. 5 100-1e) and results (FIG. 5 101-1r 102-1r) back to the origin and to other child streams or record processors.

FIG. 3 depicts the the Record Processing System. A stream contains a list of complex records 100, 101, . . . , 103. Complex records are broken down into domain datasets. The domain datasets 101-1-1 are stored in an Information Management Requests (IMRs) 101-1 & 101-2. The IMR contains a domain dataset 101-1-1, a doAction( ) 101-1-2 which is the action to take to combine the IMR:dataset 101-1-1 with the datathread:currentValue 402, and an undoAction( ) 101-1-3 which is the action to take on a failure condition related to the doAction 101-1-2 or storage (See FIG. 4). Complex record 101, shown in the datastream as well as below it, shows a domain dataset breakdown of complex records into IMRs.

IMRs query a datathread pool and if a segment's corresponding data is NOT in an existing datathread, a new datathread is created by reading the domain dataset out of the datastore and storing it in a new datathread:repositoryState. The datathread has three types of components: (1) datathread:repositoryState 401, an original value that was read from the data store, (2) datathread:currentValue 402, The value of the datathread after modifications by the IMR, and (3) a list of all the IMRs that have impacted the datathread. Modifications contain a pointer back to the complex record so that propagation of error message (FIG. 5 100-1e) and result (FIG. 5 101-1r 102-1r) can proceed through the datastream, any and all parent and related data streams and ultimately back to the record origin.

The invention incorporates two methods for creating a datathread. When reading the domain dataset out of the datastore it can then be put in the datathread:repositoryState and the datathread:currentValue, or it can put the domain dataset into only datathread:repositoryState and set the currentValue when the IMR is added, or it can put the domain dataset into the datathread:repositoryState and calculate all the IMRs into datathread:currentValue after all Complex Records have been processed and just before data store write.

FIG. 4 depicts the data store write. Complex records are depicted in blox 100 to 103 (including “n” blocks in between). Block 104 depicts a pointer into the stream. Everything before Block 104 has been processed (datatthread processing, data store write, results processing) successfully. Block 104 and everything after it is to be processed. Block 105 depicts the end of a set of data going into the data store. Block 105 points at block 103 in the diagram but block 103 may not exist at the time of creation of the 105 pointer. Block 105 may be time based, increment based or otherwise based and therefore may point to block 103 before block 103 exists or is known.

Once all IMRs are processed (as noted by records between 104 and 105 inclusive) datathreads are stored in the database. Specifically, the CurrentValue 402 for each datathread replaces the data store domain dataset value with the datathread Current Value 402.

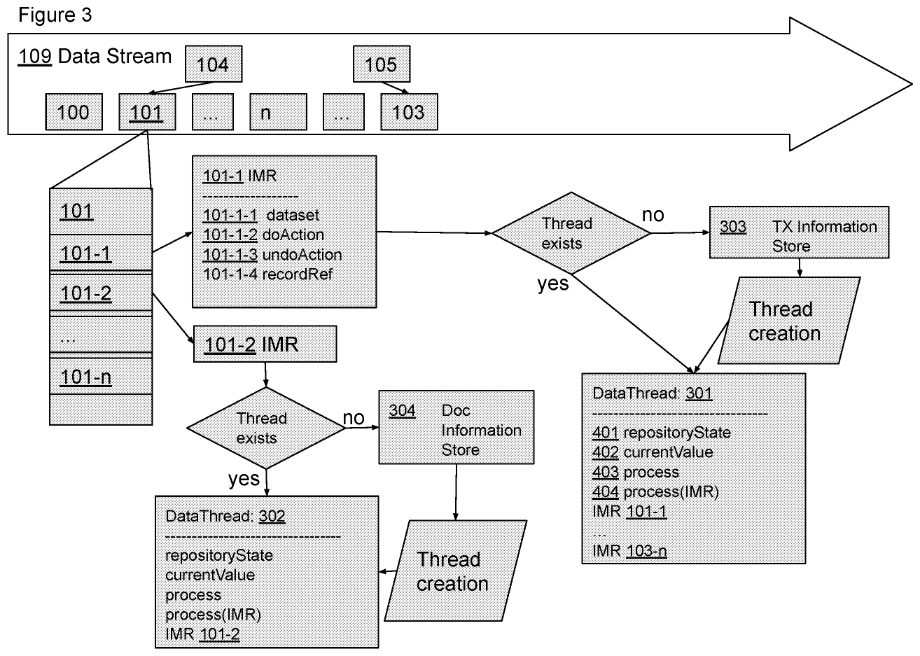

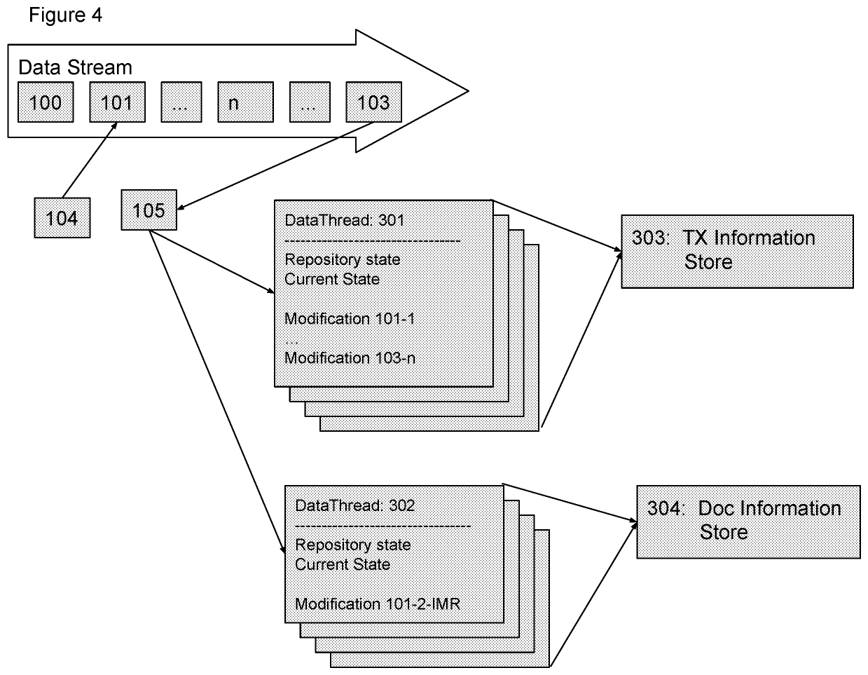

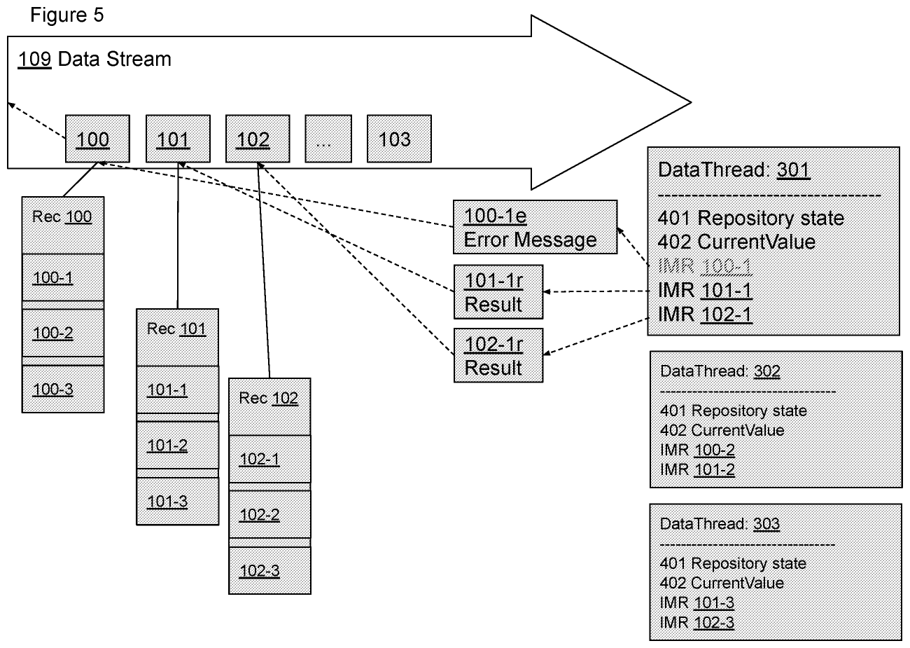

FIG. 5 depicts response processing. IMRs are stored in datathreads and each IMR recalculates its datathread:currentValue:402. In the event of an IMR calculation or a data thread storage error, an error message 100-le is propagated. As pictured, IMR 100-1 has created an error message 100-1e which is propagated back to the record and then back to the record originator to notify the originator of the error. This error causes all IMR 100-n, where n could be any number, to be removed from any thread. In this case IMR 100-2 is removed and its datathread 302 is re-processed using the process method (FIG. 3 403). All datathreads with a removed IMR are recalculated with the remaining IMRs.

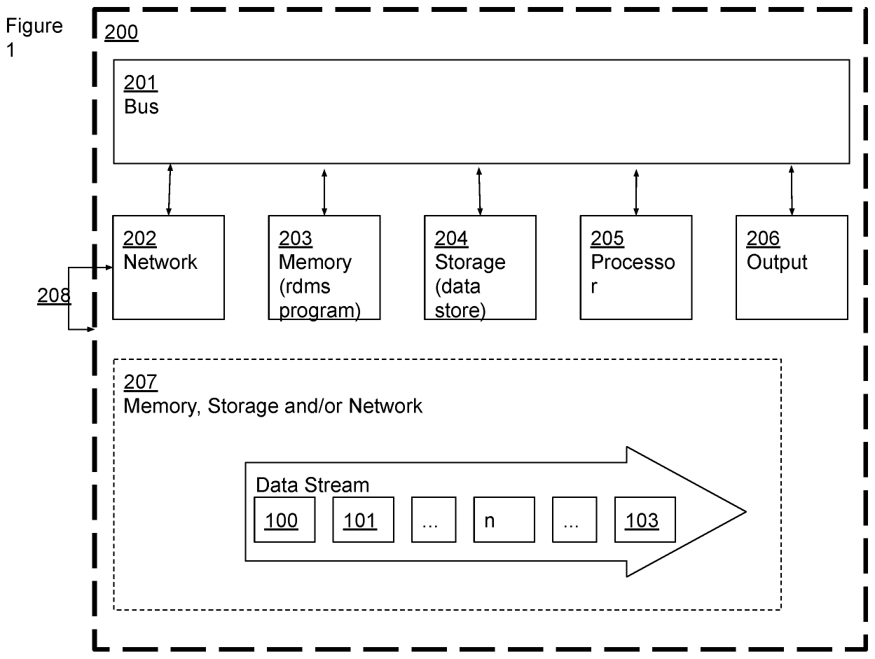

Without errors, pointer block 105 plus one record in FIG. 1 becomes pointer block 104—pointing at the next unprocessed record. More records are created and a new block 105 is created so that FIG. 1 looks like it did before except that blocks 104 and 105 both point at different records further down the datastream. Finally, the results 101-1r and 102-1r may be sent back to the origin originator.

### DETAILED DESCRIPTION OF CURRENT EMBODIMENT

A method and apparatus for implementing a database management system. In the following description for the purposes of explanation, numerous specific details are set forth in order to provide a thorough understanding of the present invention. It will be apparent, however, to one skilled in the art that aspects of the present invention may be practiced without other aspects of the present invention. In some instances, well known structures and devices are shown in block diagram form in order to avoid unnecessarily obscuring the present invention.

Hardware Overview:

FIG. 1, one or more computer systems on which the present embodiment of the invention can be implemented is shown as 200. 205 is a processor capable of communicating the results of processing across a bus to the other elements of the system 202, 203, 204, 206. System 200 further comprises a random access memory (RAM) or other dynamic storage device 203 referred to as memory. Memory 203 is coupled to the bus 201 for storing information and instructions to be executed by processor 205. Memory 203 may also be used for storing temporary variables or their intermediate information during execution of instructions by processor 205. Computer systems 200 also comprises a read only memory (ROM), processor based memory, multiple processors and other details not pictured. Static storage 204 is also coupled to the processor through the bus 201 to store static information and instructions for processor 205.

A network 202 coupled to bus 201 or storing information, instructions and either directly coupled or through a network connection 208 to a similar computer 200 through a network 202 and a bus 201, a second computer's 200 network 202, bus 201 and other components (202, 203, 204, 205) and may ultimately represent a “disk” or other form of static memory. Other input, output and control devices may be connected to the bus 201 or network 202 as well.

In the current embodiment of the invention a series of computer systems 200s may be linked together 208 and configured to execute a data store as well as store.

Datastream Overview:

FIG. 1 pictures a datastream 207 as a component of network 202, memory 203 and storage 204. In that representation, the datastream or parts of it may exist in all these locations on multiple computers 200 simultaneously or sequentially. 207 exists in multiple locations and is connected through the bus 201 and the network 202.

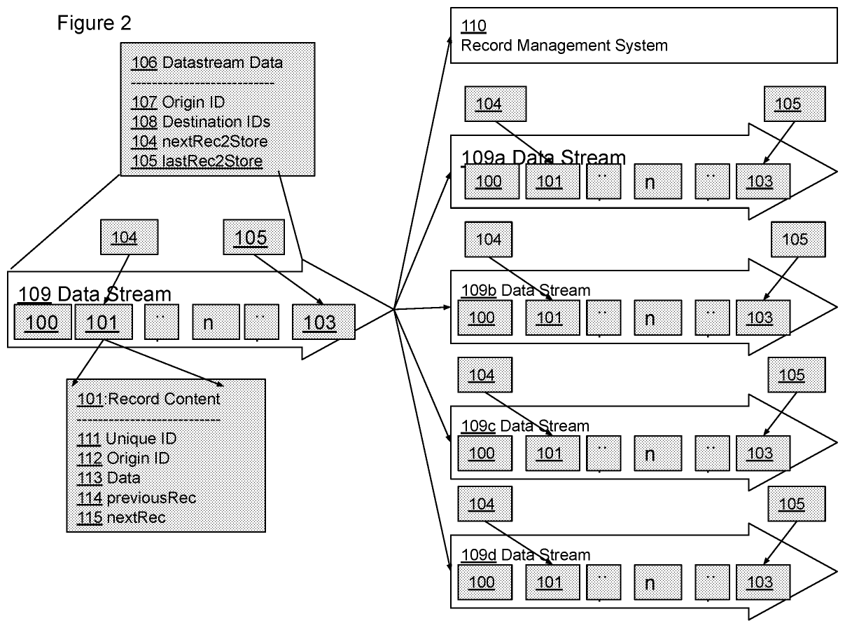

FIG. 2 depicts the connections of a datastream 109 to record management systems 110 and additional datastreams 109a-d. Connections depicted are not exhaustive and are exemplified. Datastreams 109, 109a-d can form a graph many layers deep with record management systems 110 at the leaf nodes. Only two layers are pictured. As noted in FIG. 3, record management systems 110 can also simultaneously address multiple DBMSs. The datastream takes complex records and either copies them to a new datastream or to a record management system. A single record management system can feed multiple DBMSs. To do this, the domain manager has the option to work with domains from several DBMSs simultaneously.

In the current embodiment of the invention, the datastream is responsible for (1) routing the records to the appropriate down stream component (datastream or record management system), (2) the datastream is responsible for tracking which of its complex records have completed all of the complex record's storage and response requirements. In this respect the datastream becomes a journal of all records in flight and their state within the system. It does this by (1) keeping a record of all data going through the data stream, (2) keeping a pointer to the next record to be stored 104 and (3) keeping a pointer to the last record to be processed 105 before all the records from the record 104 is pointing at through the record 105 is pointing at. When these records are witten, 104 becomes the record 105 (105+1) and a new 105 is chosen which may not exist in the stream yet.

The records in the stream may accomplish storage, queries or query the DBMS which would render a status.

The datastream holds a next record to store 104 and a last record to store 105. If the target DBMS has a record locking system the record management system will have the option to do no record locking, lock records on read of data into datathreads or lock records on the start of the datathreads write. If record locking is done, it is unlocked after the datathreads write is complete.

FIG. 2 depicts the datastream data 106 associated with each datastream 109, 109a-d. Origin id 107 is a pointer to the originating datastream or null if there are no previous data streams. Destination ids 108 is a set of pointers to datastreams. Next record to store 104 is a pointer to a record in the stream that indicates (1) that all records before this have been stored and (2) that this record and following records have not been stored. Last record to store 105 is a pointer which indicates the last record to process before the Record Management System described here in stores all datathreads (FIGS. 3 107 and 109 non-exhaustive examples) back to the data store.

FIG. 2 pictures a datastream 109 comprised of an unspecified number of records with each record having content 101 including data 113, a unique id 111 and an origin id 112. Data 113 comprises record 101 . . . 103 information, segments of data with meaning. Unique id 111 is a unique identifier for that record and may be of type integer, time or any other unique identifier. The unique id 111 may also imply stream sequence. If sequence is not implied by the unique id 111 then a previous record 114 and a next record 115 may be used to traverse the stream. The originator (not pictured) the program, machine, sensor or individual who added this information to the stream either directly or through a computer 200. The origin id 112 is a pointer back to the originator for the purpose of notifying the originator of the status of the record.

The datastream stores its metadata to permanent storage and some segment of records including all records from the last record to store till the end of the stream. In this way, the datastream becomes the system of last resort in recovery—providing a recovery method for data in its pre-processed state.

The Record Processing System

Domain processing in the new invention is the process of taking a complex records, breaking them into domains, creating IMRs for each domain dataset, and applying the IMR to the appropriate datathread. This designation dose not include data store write and results processing activities.

Data store write in the new invention is the writing of all datathreads to the data store. All datathreads have to write at the same time after having completed a fixed record. A data store write also includes a reset of the data threads.

Datathread reset in the new invention is when all the datathreads are deleted or reset to the current state of the datastore. A datathread reset either (1) removes the datathread entirely, or (2) removes the IMRs from all the datathreads and sets the DataThread:RepositoryState (FIG. 3 401) to the datathread:currentValue (FIG. 3 402).

Results processing in the new invention is the process of returning error messages (FIG. 5 100-1e) and results (FIG. 5 101-1r & 102-1r) to their origin.

FIG. 3 shows a datastream 109 with complex records in it. Record 101 is broken down into domain tuples labeled Information Management Requests (IMR) 101-1, 101-2, 101-n. IMR 101-1 contains (1) Data 101-1-1 which may be any set of data identified in the record, (2) a do action 101-1-2 which may be text, code or reference describing an action to modify the datathread:currentValue 402 based on this IMR, (3) an undo action 101-1-3 which may be text, code or reference describing an action to modify the datathread:currentValue 402 to remove this IMR from it, and (4) a record reference 101-1-4 that indicates the complex record in the datastream that created the IMR.

The process of breaking a complex record into IMRs and associating them with datathreads requires each IMR 101-1 . . . n result in a query to find the datathread. If the datathread does not exist it is created. The IMR is then stored the resulting datathread object.

Multiple complex records creating multiple IMRs which are put in multiple datathreads results in each datathread having a set of IMRs (datathread IMR set) associated with it. Any complex record which has a failing IMR results in all the IMRs associated with that specific complex record to be removed from the datathread IMR set. In the case of an error in any of the complex record's 101 IMRs, result in all the other 101 IMRs removed from their respective datathread IMR sets.

IMRs may fail due to several reasons. A subset is listed here:
1. The data in the IMR is incompatible with the data in the datathread resulting in a data-type error.
2. The data in the IMR may be out of range resulting in a data-range error.
3. The IMR doAction 101-1-2 may fail resulting in a doAction error.
4. The IMR undoAction 101-1-3 may fail resulting in an undoAction error.
5. The data in the IMR may, when calculated with the datathread currentValue: 402 may exceed the limit in the data thread resulting in a limit error.
6. The datathread storage may fail resulting in a storage error.

Datathreads are a combination of (1) an in memory element of a data from a data store 401, (2) a representation of that data element 402, (3) a list of values and instructions for modifying the datathread, (4) the ability to invoke instruction sets in the IMR in a thread-safe manner.

When IMR execution fails, a failure of the datastream complex record 101 is processed. As noted all the IMRs associated with all the domains of that record are then removed. This is accomplished by using the IMR record reference 101-1-4 to obtain the complex record 101 and then accessing each IMR and executing the IMR undoAction 101-1-3.

When a datathread has an IMR removed, depending on the data requirements, the IMR undoAcation 101-1-3 can be executed resulting in a change to the current value directly or the IMR can call the datathread process 403 method which goes through all the IMR doActions 101-1-2 in the datathread IMR set.

The current embodiment also enables the datathread to do an IMR post-process. In a post-process, the IMR is added to the datathread and doAcation 101-1-2 is not called. Instead, the datathread calls process 403 only after all IMRs are added to the data thread. The domain manager may then choose which high risk domain datathreads to execute first and may keep statistics or Al on most efficient orders of process. Program efficiencies involving the statistical rate of errors, the number of IMRs per datathread, and the number of IMRs per complex record may or may not make post-processing more efficient than processing IMRs doAcation 101-1-2 when they are added to the thread.

The current embodiment identified several different ways to handle complex records in the datastream when an IMR failed resulting in the complex record not being stored. They are: Rollback Local simply moves block 105 pointer upto the error record minus one position, removes all the modifications in all the datathreads up to that position and commits the datathreads. Then moves block 104 to block 105 and defines a new block 105 for the current data stream. Then propagates an error message back to the message origin as defined in the current record.

Rollback DataStream Global performs a rollback local for each data stream in the cluster of leafs propagating from the leaf datastreams to the root datastream.

Ignore Record Domain removes the IMR associated with the error and continues. In this instance, database design and intent is considered and a decision is made to ignore the current error, not letting the domain dataset impact the resulting database but letting the complex record continue.

Ignore Record removes all the modifications associated with that record in the current datastream and sends an error message to parent data streams and ultimately to the record's message origin.

Ignore Record Global performs an Ignore Datastream Local for each datastream containing this record.

Special Instruction performs any combination of Rollback and Ignore with additional instructions to create new records for new data streams. This is useful in cases where an error creates an error record in a new data system. For example, a credit card failure may propagate a record into a customer tracking database.

The record management system is capable of storing several complex records at once and does this while maintaining ACID. When all the complex records have each domain set isolated, updated and then written to the data store, ACID is maintained. This is quite different from that traditional data store approach of taking each individual record, locking all of its domain sets, reading each of the domain sets, updating each of the domain sets and then writing the new values back to the data store.

It is an important innovation because the work done by the current invention is dramatically less and yet the results are identical. The difference becomes more dramatic when one realizes that the traditional system needs to either update all the indexes for the entire domain with every record or create a sophisticated journaling system with multiple reads to know the current state of the system. In the traditional system, the more complex record domains overlap the slower it takes to rebuild the data store and keep it consistent. In the new invention, the more complex records overlap domain sets the more efficient the system becomes.

The basic rule is that a data store using the new invention, must access all data through datathreads or read and store the datathreads in the DBMS's base transactional system. It is noted however that some applications may allow the DBMS to either do transactional management only during the write phase or not at all while still maintaining an ACID system.

Once all the complex records have been processed through the end marker (FIG. 2 105) a datathread reset is done. Datathread reset in the new invention is the process or resetting all the datathreads by either (1) deleating the datathreads and the datathread pool entirely, or (2) remove the IMRs from all the datathreads and set the DataThread:RepositoryState (FIG. 3 401) to the datathread:currentValue (FIG. 3 402).

The new invention also introduces a new client/server model. In the new model, the client submits a record which has implicit or explicit processing requirements. Once the record is processed the client gets the results. This is the inverse of the existing client/server models where a client reads data, processes data and then updates the server (DBMS) with the results.

Recovery

The new invention recovers from failures, minor or catastrophic, in the domain processing layer by treating the datastream as the system of record. Data coming into the stream is recorded in a file of arbitrary, ordered length of the stream. The requirement for the recorded data of the stream is that it is a superset that includes all the records between next record to store 104 and the end (most recent record) of the stream. Because the stream is a derivative of the storage, it can become the “authority” on the condition of the system. That is, given the impossibility of a transactional based error, the value can be assumed to be stored when it reaches the stream, not when it reaches the data store.

1. A method of operating a computer system that uses a datastream of complex records as the means to update or access one or more data stores, the data stream complex records, each containing overlapping sets of data elements, each set corresponding to a specific domain in a data store, each complex record sent to the stream by one or more data stream input systems for the purpose of storing the record in the data store and/or observing the current state of the data store.

2. A data stream as recited in claim 1 where the stream can be used as a journal that can be played forward and backward to update stored data, handle errors, recover data or restore part or all of a data store.

3. A data stream as recited in claim 1 where the data stream contains a pointer or reference to a data stream input system callback such that the data stream can update the input system as to results of any record in the datastream including but not limited to the following types of information:
a. Completed—storage of the stream to the new format is complete to this point,
b. Processing—the current point in the stream that the system is attempting to process,
c. Result—the resulting data returned based on the record request (a query report),
d. Failed—the specified record at this point has failed and will not be stored but optionally may have the following additional conditions:
i. Ignore—do nothing all non-failed parts of the data record to remain in the new format;
ii. Remove—in the event of a failure remove all non-failed parts of the data record from the new format;
iii. Rollback—roll the data state and the new format to just before the failed record, remove the failed record from the stream, and proceed to store the new record.

4. A data stream as recited in claim 1 and modified by claims 2 and 3 where complex records consist of elements; groups of elements forming sets where an element can exist in several sets, each set pertaining to a domain in a storage system; a data stream of complex records are stored in a data store allowing that each set pertaining to a storage domain in the data store is stored in the order that it occurs in the data stream's complex records; corresponding domains for any given complex record are not necessarily stored at the same time but eventually are stored in the data store; data integrity being maintained by all domains for a complex record being stored based on the ultimate success of all domain sets of a complex record being stored successfully or any one domain set failing to store causing the other domains to be removed from the storage order; the data stream being capable of being played forward and backward to accomplish this result; or the rules around domain storage allowing for particular domain set failures to be ignored as described in claim 3.d.i, claim 3.d.ii, claim 3.d.iii or other conditions not specified.

5. A datastream as recited in claim 1 and optionally modified by claims 2, 3 & 4 capable of dynamically or statically calculating the size of data to be processed in a single group by observing mean time and mean number of records between records with errors, observing the resource cost of an error, observing record supply to record management system, observing available memory, or calculating the optimal number or records to process in a given set or subset of parameters potentially including record errors, cost of errors, record volume, or available memory.

6. A data stream as recited in claim 1 capable of replicating itself or part of itself and storing the newly replicated data stream in a data store independent from the data store of the original stream while optionally including a callback, pointer or reference method for communicating storage and data store results through the newly created stream network.

7. A method for operating a computer system to create a datathread, a data thread being an in program representation of a unique set of data (a set) within a data store domain; the in program datathread being the only way to read or write data from the data store domain specifically limited as such by program controls where upon multiple datastream complex record domain sets can operate on a single datathread and use the programming convention known as a synchronous thread to control access to the domain information to prevent multiple complex record domain sets from reading or writing to the datathread simultaneously.

8. A datathread as recited in claim 7 where in preprocess instructions are added by the input system or by the data stream processing system to:
a. define a method to get the domain set from a data store;
b. define a method to update a domain set;
c. A method as recited in claim 8.b optionally including a calculation to be returned to the data stream input system via the datastream reference defined in claim 3 upon a successful datathread update or datathread storage to the data store or both update and storage;
d. define a method to delete a domain set;
e. define a method for getting the current state of a data domain set form the data store;
f. define one or more methods for handling errors and exceptions that may occur in a datathread;
g. or any other method to insure a datathread integrates smoothly with a datastream as described by actions in claim 3;
h. or any other method needed to customize a datathread to a specific data store.

9. A method for operating a computer system that takes data from one or more input systems and stores it in one or more data stores by defining inputs as a set of different types of complex records and storing them with a transactional boundary around a set of some or all of the complex records allowing each record to be reduced to a series of domains resulting in a series of domains each domain containing a series of sets; where in, each domain and each set within each domain can be stored in any order so long as the sets in any given domain maintain the same order with an optional requirement that the sets may need to be stored in the same order as the original group of complex records; where in the set may be ordered and processed forward and backward throughout this process to handle errors; where in the final result is all records being stored or given an error state and optionally status reported back to the input system; the transactional boundary used to accomplish an ACID database management system.
